(19) United States
(12) Patent Application Publication
(10) Pub. No.: US 2026/0145147 A1
(43) Pub. Date: May 28, 2026

(54) MIXING DEVICES FOR SELECTIVE CATALYTIC REDUCTION FLUID GENERATORS

(71) Applicant: CHANGZHOU UNIVERSITY, Changzhou (CN)

(72) Inventors: Xiangji DOU, Changzhou (CN); Shaopeng SUN, Changzhou (CN); Zhengdong LEI, Changzhou (CN); Tengfei HOU, Changzhou (CN); Kun QIAN, Changzhou (CN); Zhilin WANG, Changzhou (CN); Wenlong GUAN, Changzhou (CN); Erpeng GUO, Changzhou (CN)

(73) Assignee: CHANGZHOU UNIVERSITY, Changzhou (CN)

(21) Appl. No.: 19/401,301

(22) Filed: Nov. 25, 2025

(30) Foreign Application Priority Data
Nov. 27, 2024 (CN) 202411711966.6

(51) Int. Cl. B01F 27/1144; B01F 27/091; B01F 27/72; B01F 35/12; B01F 35/22; B01F 35/221; B01F 35/91

(52) U.S. Cl. CPC B01F 27/1144; B01F 27/091; B01F 27/725; B01F 35/123; B01F 35/2202; B01F 35/221422; B01F 35/2215; B01F 35/91

(57) ABSTRACT

A mixing device for a selective catalytic reduction fluid generator is provided. The device includes: a mixing cylinder having a mixing chamber, wherein an air outlet channel and an air inlet channel is respectively formed on a right end surface and a left end surface of the mixing cylinder; a first material pipe extending into the mixing cylinder, the first material pipe and the mixing cylinder being coaxially arranged, wherein a plurality of first through-holes are provided on the first material pipe at intervals along an axial direction of the first material pipe, and a scraper is fixed on the first material pipe; a second material pipe extending into the mixing cylinder, the second material pipe being sleeved on the first material pipe; a driving assembly for providing power for rotation of the scraper and the mixing blades; and a purification mechanism for removing impurities in a fluid.

### CROSS-REFERENCE TO RELATED APPLICATIONS

This application claims priority to Chinese Patent Application No. 202411711966.6, filed on Nov. 27, 2024, the entire contents of which are hereby incorporated by reference.

### TECHNICAL FIELD

The present disclosure relates to the field of mixing devices, and in particular, to a mixing device for a selective catalytic reduction fluid generator.

### BACKGROUND

A Selective Catalytic Reduction (SCR) device utilizes a reducing agent (e.g., ammonia, urea, etc.) to react “selectively” with NOx in exhaust gas in the presence of a catalyst, generating nitrogen (N₂) and water (H₂O). This process aims to reduce NOx content in engine or industrial emissions to comply with environmental regulations.

A common problem with existing mixing devices during operation is the tendency for exhaust gas and the reducing agent solution to form crystals during the reduction reaction, often due to improper temperature control or variations in other operating conditions. Crystals deposit inside a pipe, a valve, a pump, or other equipment, gradually accumulating and potentially causing severe blockage of fluid passages, thereby obstructing normal fluid flow. This not only increases fluid transfer resistance but may also directly lead to equipment failure, impacting the continuity and stability of the entire production process. Furthermore, the formation of crystals significantly reduces the efficiency of the reduction reaction. The crystals occupy substantial reaction space, reduce the effective reaction area, and consequently lower the reaction rate. More seriously, the crystals may encapsulate portions of the reducing agent or catalyst, forming an isolation layer that prevents these key components from directly contacting the exhaust gas, which further diminishes catalytic effects of these key components, resulting in a substantially compromised reduction reaction efficiency. Therefore, improvements and optimization of existing mixing devices are necessary.

### SUMMARY

One or more embodiments of the present disclosure provide a mixing device for a selective catalytic reduction fluid generator. The mixing device includes a mixing cylinder, a first material pipe, a second material pipe, a driving assembly, and a purification mechanism. The mixing cylinder has a mixing chamber. An air outlet channel is formed on a right end surface of the mixing cylinder, and an air inlet channel is formed on a left end surface of the mixing cylinder. The first material pipe extends into the mixing cylinder, the first material pipe and the mixing cylinder being coaxially arranged, wherein a plurality of first through-holes are provided on the first material pipe at intervals along an axial direction of the first material pipe, and a scraper is fixed on the first material pipe, the scraper being located in the mixing chamber of the mixing cylinder and in contact with an inner wall of the mixing chamber of the mixing cylinder. The second material pipe extends into the mixing cylinder, the second material pipe being sleeved on the first material pipe, wherein a plurality of second through-holes are provided on the second material pipe at intervals along an axial direction of the second material pipe, and in a plane of rotation, each of the plurality of first through-holes corresponds to one of the plurality of second through-holes, such that when the plurality of first through-holes and the plurality of second through-holes are aligned, a pipe lumen of the first material pipe is in fluid communication with the mixing chamber of the mixing cylinder; and mixing blades are installed on the second material pipe. The driving assembly provides power for rotation of the scraper and the mixing blades, wherein an output end of the driving assembly is drivingly connected to the first material pipe and the second material pipe to drive the first material pipe and the second material pipe to rotate at different speeds. The purification mechanism removes impurities in a fluid, and the purification mechanism is disposed in the air outlet channel.

In some embodiments, the mixing blades are spirally distributed.

In some embodiments, the driving assembly includes a motor, a first bevel gear, a second bevel gear, and a third bevel gear. An output shaft of the motor is drivingly connected to the third bevel gear, the first bevel gear is installed on the first material pipe, the second bevel gear is installed on the second material pipe, and the third bevel gear meshes with the first bevel gear and the second bevel gear. A transmission ratio between the first bevel gear and the third bevel gear is different from a transmission ratio between the second bevel gear and the third bevel gear.

In some embodiments, the purification mechanism includes a power fan, a transmission assembly, and a filter plate. The power fan is rotatably connected to the air outlet channel, the filter plate is rotatably connected to the air outlet channel, the filter plate and the air outlet channel are coaxially arranged, and the power fan is drivingly connected to an input end of the transmission assembly. An output end of the transmission assembly is drivingly connected to the filter plate, and the power fan is configured to be driven by a wind force to rotate the filter plate in a circumferential direction of the filter plate.

In some embodiments, the purification mechanism further includes a scraping strip, the scraping strip is fixedly connected to the air outlet channel, and the scraping strip contacts an end surface of the filter plate, the end surface being close to an input end of the air outlet channel.

In some embodiments, the purification mechanism further includes a fixed block. The fixed block is located in the air outlet channel and fixedly connected to the air outlet channel, the filter plate is fixedly connected to the fixed block, and the filter plate is located between the fixed block and the scraping strip.

In some embodiments, the transmission assembly includes a first rotating shaft, a second rotating shaft, a fourth bevel gear, a fifth bevel gear, a mounting seat, a transmission belt, and a transmission gear. The first rotating shaft is rotatably connected to the air outlet channel, the power fan is fixedly connected to the first rotating shaft, an end of the first rotating shaft extends to an outer side of the air outlet channel and is provided with the fourth bevel gear, the fourth bevel gear meshes with the fifth bevel gear. The second rotating shaft is rotatably connected to the mounting seat, the fifth bevel gear is disposed on the second rotating shaft, an outer periphery of the filter plate is provided with teeth, the transmission gear meshes with the teeth on the filter plate, the transmission gear is rotatably connected to the mounting seat through a transmission gear shaft, and the transmission belt is wound around the second rotating shaft and the transmission gear shaft.

In some embodiments, the purification mechanism further includes a collection box for accommodating impurities filtered by the filter plate. The collection box is fixedly connected to the air outlet channel, a box opening of the collection box is located between the filter plate and the power fan, and the box opening of the collection box is in fluid communication with the air outlet channel.

In some embodiments, a temperature controller is installed on the air inlet channel.

In some embodiments, a collection channel is formed on the mixing cylinder, and a plug is disposed in the collection channel.

In some embodiments, the mixing device further includes a controller, and the driving assembly further includes a frequency converter. The frequency converter is configured to control a rotational speed of the motor. The frequency converter is communicatively connected to the controller, and the controller is configured to perform, at every preset period, operations including:
determining pressure difference data based on pressure data of the air inlet channel and pressure data of the air outlet channel; and determining a target rotational speed based on the pressure difference data and a mixing temperature, and controlling the rotational speed of the motor through the frequency converter based on the target rotational speed.

In some embodiments, the controller is further configured to: in response to a historical pressure difference feature or a historical temperature feature being greater than a corresponding control threshold, determine the target rotational speed based on the pressure difference data and the mixing temperature.

In some embodiments, the controller is further configured to: determine the target rotational speed based on the pressure difference data, the mixing temperature, a blockage feature, and a reaction feature.

In some embodiments, the mixing device further comprises a controller; the temperature controller is communicatively connected to the controller, and the controller is configured to perform, at every preset period, operations including: determining a blockage feature and a reaction feature based on gas composition data of the air outlet channel; determining a target temperature based on the blockage feature and the reaction feature; and controlling the temperature controller to adjust a gas temperature in the air inlet channel to the target temperature.

### BRIEF DESCRIPTION OF THE DRAWINGS

The present disclosure will be further illustrated by way of exemplary embodiments, which will be described in detail through the accompanying drawings. These embodiments are not limiting, and in these embodiments the same numbering indicates the same structure, wherein:

FIG. 1 is a schematic structural diagram of a mixing device according to some embodiments of the present disclosure;

FIG. 2 is a schematic cross-sectional structural diagram of a mixing device according to some embodiments of the present disclosure;

FIG. 3 is a schematic cross-sectional diagram taken at an air outlet channel of a mixing device according to some embodiments of the present disclosure;

FIG. 4 is a schematic structural diagram of a purification mechanism according to some embodiments of the present disclosure;

FIG. 5 is a partial schematic structural diagram of an air inlet channel according to some embodiments of the present disclosure;

FIG. 6 is an exploded structural diagram of a first material pipe and a second material pipe according to some embodiments of the present disclosure; and

FIG. 7 is an enlarged schematic structural diagram of a portion A in FIG. 6.

Numeral references in the drawings: 1: mixing cylinder, 11: mixing chamber, 12: air outlet channel, 13: air inlet channel, 131: temperature controller, 14: collection channel, 15: plug;
2: first material pipe, 21: first through-hole, 22: scraper;
3: second material pipe, 31: second through-hole, 32: mixing blade;
4: driving assembly, 41: motor, 42: first bevel gear, 43: second bevel gear, 44: third bevel gear;
5: purification mechanism, 51: power fan, 52: transmission assembly, 521: first rotating shaft, 522: second rotating shaft, 523: fourth bevel gear, 524: fifth bevel gear, 525: mounting seat, 526: transmission belt, 527: transmission gear, 53: filter plate, 54: scraping strip, 55: fixed block, 56: collection box.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

The deposition of crystals inside a pipe, a valve, a pump, or other equipment may lead to gradual accumulation and severe blockage of fluid passages, thereby obstructing normal fluid flow. This not only increases fluid transfer resistance but may also directly cause equipment failure, affecting the continuity and stability of an entire production process.

In some embodiments of the present disclosure, a mixing device for a selective catalytic reduction fluid generator (hereinafter referred to as the “mixing device”) is provided. The rotation of a second material pipe drives spirally distributed mixing blades to generate a strong stirring effect. The spiral arrangement of the mixing blades not only increases a length of a fluid flow path within a mixing cylinder but also promotes exchange and mixing between different fluid layers, thereby significantly improving mixing efficiency. The rotation of the spirally distributed mixing blades facilitates the formation of vortices within the mixing cylinder. These vortices can further accelerate a fluid mixing process, resulting in a more uniform distribution of various components within the fluid and enhancing both mixing uniformity and efficiency. As a first material pipe rotates, an L-shaped scraper scrapes an inner wall of the mixing cylinder, effectively preventing the formation of deposits or scaling during the mixing process. This not only reduces the cleaning workload for the mixing cylinder but also extends the service life of the mixing device. Traditional mixing devices may suffer from issues such as non-uniform mixing, susceptibility to scaling, and difficulty in cleaning. Compared to traditional mixing devices, the mixing device according to some embodiments of the present disclosure offers significant advantages in terms of mixing efficiency, process stability, and cleaning maintenance, thereby improving the overall performance and reliability of the mixing device. Furthermore, through the design of a purification mechanism, impurities within the fluid can be removed, enhancing the cleanliness of the post-reaction product.

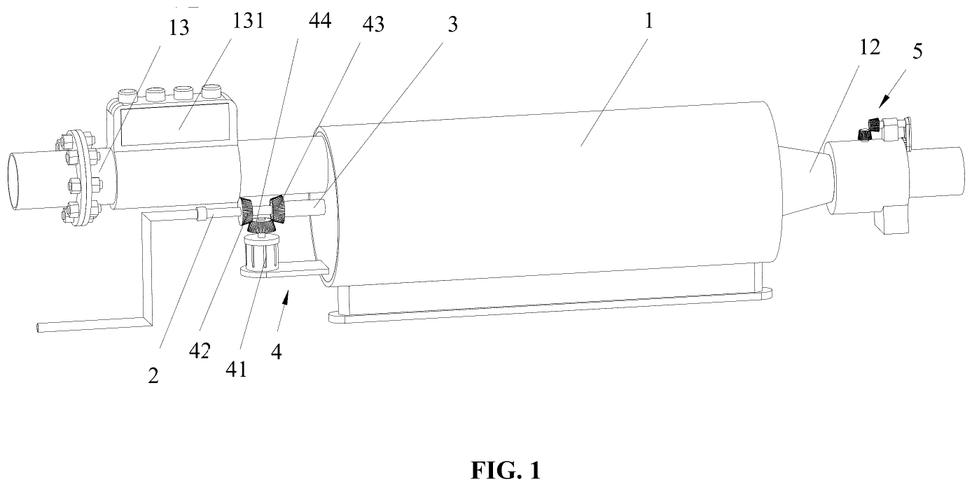

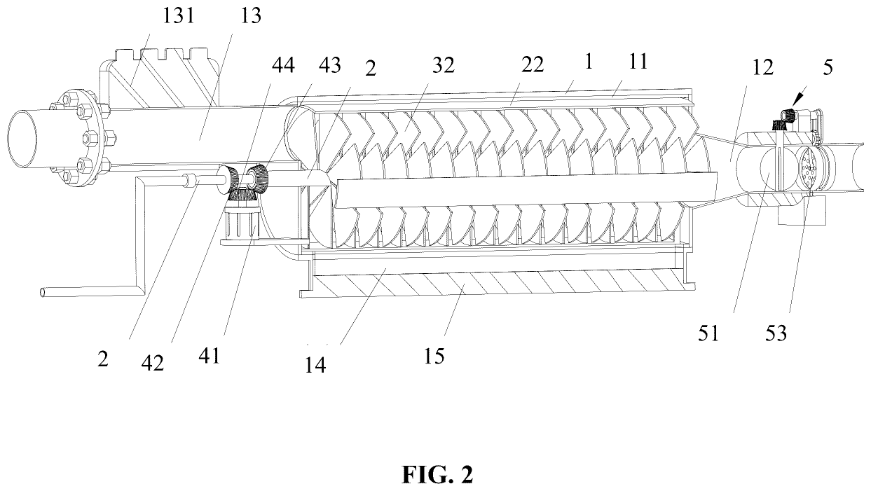

FIG. 1 is a schematic structural diagram of a mixing device according to some embodiments of the present disclosure. FIG. 2 is a schematic cross-sectional structural diagram of the mixing device according to some embodiments of the present disclosure. As shown in FIGS. 1 and 2, a mixing device for a selective catalytic reduction fluid generator includes: a mixing cylinder 1, a first material pipe 2, a second material pipe 3, a driving assembly 4, and a purification mechanism 5.

The mixing cylinder 1 refers to a primary container for reaction and is a hollow cylindrical structure. The first material pipe 2 is a component that acts as a conveyance carrier for a reducing agent. The second material pipe 3 is sleeved over the first material pipe 2. The driving assembly 4 is a component that drives the first material pipe 2 and the second material pipe 3 to rotate. The purification mechanism 5 is a component used for filtration and cleaning.

In some embodiments, the mixing cylinder 1 has a mixing chamber 11. An air outlet channel 12 is formed on a right end surface of the mixing cylinder 1, and an air inlet channel 13 is formed on a left end surface of the mixing cylinder 1. The direction from left to right corresponds to a flow path from a raw material entering the mixing device to the output of reacted gas. The air outlet channel 12 and the air inlet channel 13 may be cylindrical or conical in shape.

In some embodiments, a temperature controller 131 is installed on the air inlet channel 13. The temperature controller 131 is configured to control a temperature (i.e., an intake gas temperature) of a gas entering the mixing cylinder. For example, the temperature controller 131 includes structures such as a temperature sensor, a controller, a heater, and a cooler. The heater may include an electric heating rod, a heating wire, a heating plate, etc. The cooler may include a condenser tube, a fan, a compressor, etc. The temperature sensor may be disposed inside the air inlet channel 13. The temperature controller 131 may control the temperature of the gas within the mixing cylinder using a closed-loop control technique, such as Proportional-Integral-Derivative (PID) control.

The air inlet channel 13 is in fluid communication with an interior of the mixing cylinder 1, ensuring that external gas can smoothly enter the mixing cylinder to provide necessary reactants or carrier gas for a catalytic reaction. The temperature controller 131 is fixedly sleeved on an outer wall of the air inlet channel 13. The temperature controller 131 may be an annular heater. The temperature controller 131 controls the temperature of the gas entering the mixing cylinder, ensuring the gas reaches an optimal temperature range for a catalytic reaction zone. By precisely controlling the intake gas temperature, conditions for the catalytic reaction can be optimized, improving reaction efficiency and product quality. A flange ring is provided at an end of the air inlet channel 13 near the temperature controller 131. The flange ring enables a secure connection between the air inlet channel 13 and other pipelines or equipment, ensuring the sealing integrity at the junction.

A collection channel 14 is formed on the mixing cylinder 1, and a plug 15 is disposed in the collection channel 14. The collection channel 14 may be an opening provided at a bottom of the mixing cylinder 1. The plug 15 is detachably connected to the mixing cylinder 1. When the plug 15 is engaged with the collection channel 14, the mixing cylinder 1 forms a sealed cavity. When the plug 15 is removed from the collection channel 14, the collection channel communicates with an external environment, facilitating the removal of crystals. Each of the first material pipe 2 and the second material pipe 3 may be provided with a notch or a hole to allow crystals to fall into the collection channel 14. By incorporating the plug 15, a user can conveniently control the retention or removal of crystals as needed.

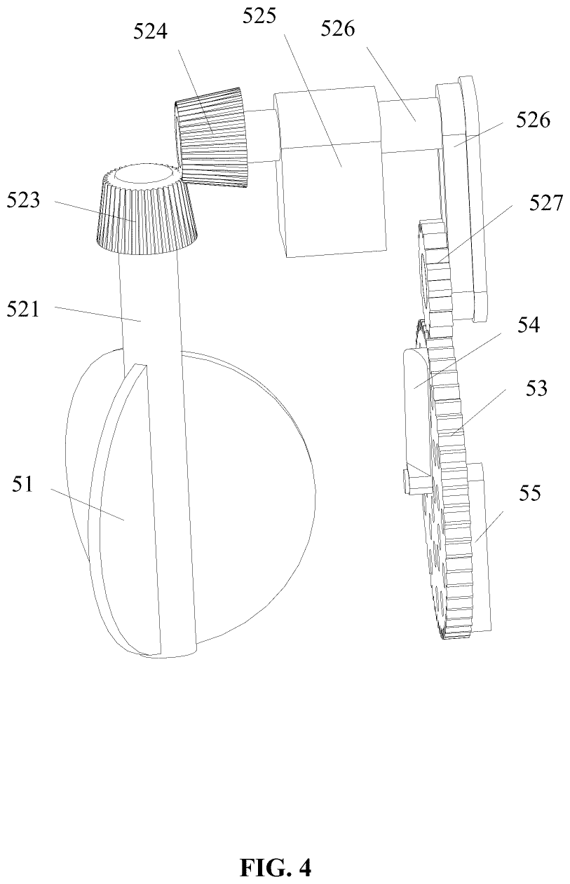

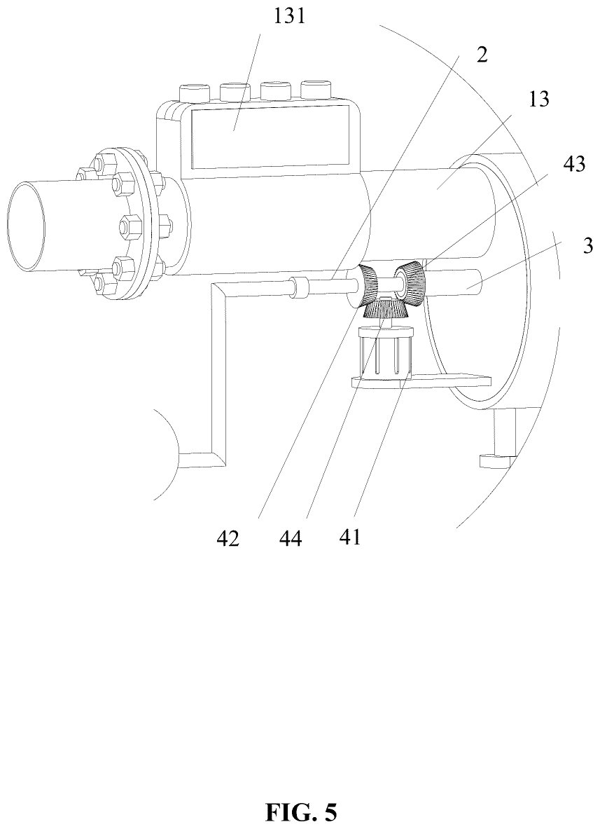

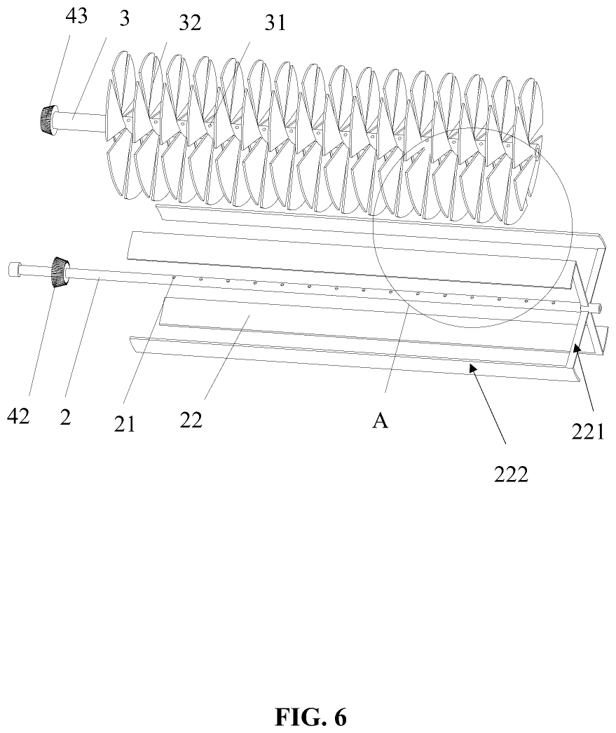

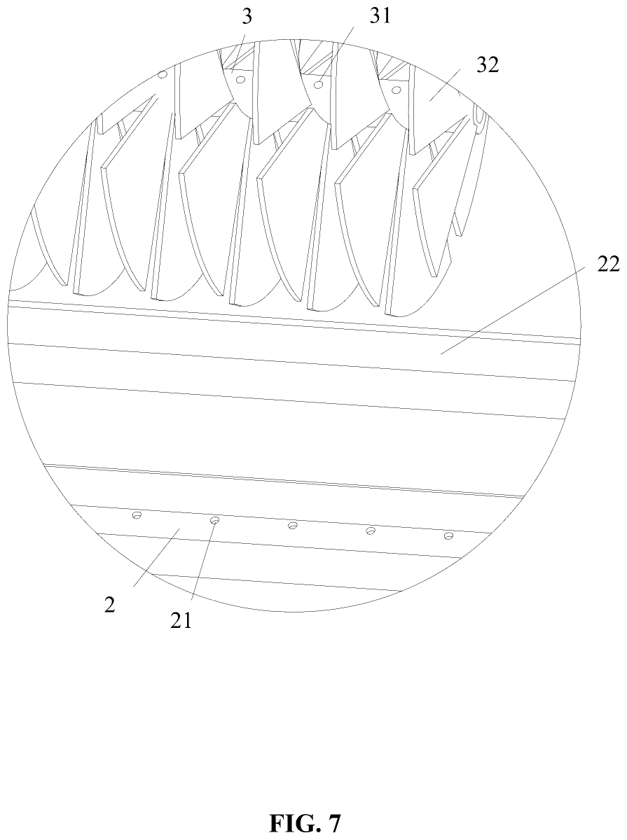

FIG. 4 is a schematic structural diagram of a purification mechanism according to some embodiments of the present disclosure. FIG. 5 is a partial schematic structural diagram of an air inlet channel according to some embodiments of the present disclosure. FIG. 6 is an exploded structural diagram of a first material pipe and a second material pipe according to some embodiments of the present disclosure. FIG. 7 is an enlarged schematic structural diagram of a portion A in FIG. 6.

In some embodiments, the first material pipe 2 extends into the mixing cylinder 1. As shown in FIGS. 6 and 7, the first material pipe 2 and the mixing cylinder 1 are arranged coaxially. A plurality of first through-holes 21 are provided on the first material pipe at intervals along an axial direction of the first material pipe 2. A scraper 22 is fixed to the first material pipe 2 and is located in the mixing chamber 11 of the mixing cylinder 1. The scraper 22 is L-shaped and contacts an inner wall of the mixing chamber 11 of the mixing cylinder 1. As shown in FIG. 6, the scraper 22 includes a short plate 221 and a long plate 222 that form the L-shape. The short plate 221 is located at an end of the first material pipe 2 along a length direction of the first material pipe 2, and the long plate 222 is located outside mixing blades 32. A distance from the long plate 222 to an axis of the first material pipe 2 is greater than an outer diameter of each of the mixing blades 32, thereby preventing dimensional interference between the scraper 22 and the mixing blades 32. The L-shaped scraper 22 may scrape the inner wall of the mixing cylinder, effectively preventing the formation of deposits or scale during the fluid mixing process.

In some embodiments, the second material pipe 3 extends into the mixing cylinder 1. The second material pipe 3 is sleeved on the first material pipe 2. A plurality of second through-holes 31 are provided on the second material pipe at intervals along an axial direction of the second material pipe 3. In a plane of rotation (i.e., a plane of revolution of the first through hole 21), each of the plurality of first through-holes 21 corresponds to one of the plurality of second through-holes 31, such that when the plurality of first through-holes 21 and the plurality of second through-holes 31 are aligned, a pipe lumen of the first material pipe is in fluid communication with the mixing chamber 11 of the mixing cylinder 1. The mixing blades 32 are installed on the second material pipe 3. That is to say, at a position corresponding to the plane of rotation of each first through-hole 21, a second through-hole 31 corresponding to the first through-hole 21 is provided. A spacing between adjacent first through-holes 21 is the same as a spacing between adjacent second through-holes 31, so that when the first material pipe 2 and the second material pipe 3 rotate at different speeds, the plurality of second through-holes 31 and the plurality of first through-holes 21 can coincide and communicate at certain time points.

In some embodiments, the mixing blades 32 are spirally distributed. The term “spirally distributed” means that the mixing blades 32 are arranged in a spiral pattern. The rotation of the second material pipe 3 drives the spirally arranged mixing blades 32 to generate a strong stirring effect. The spiral arrangement not only increases a length of a fluid flow path within the mixing cylinder but also promotes exchange and mixing between different fluid layers, thereby significantly improving mixing efficiency. The rotation of the spirally distributed mixing blades facilitates the formation of vortices within the mixing cylinder. The vortices can further accelerate the fluid mixing process, resulting in a more uniform distribution of various components within the fluid and enhancing both mixing uniformity and efficiency.

As the first material pipe 2 rotates, when the first through-holes 21 and the second through-holes 31 are not aligned, the fluid within the first material pipe 2 gradually increases, leading to a rise in pressure inside the first material pipe 2. After the first through-holes 21 and the second through-holes 31 align, the gas is ejected through the aligned first through-holes 21 and the second through-holes 31, increasing the gas flow velocity. This arrangement enhances a diffusion degree of the reaction gas within the mixing cylinder 1, resulting in a wider and more uniform distribution of the fluid inside the mixing cylinder, thereby accelerating the fluid mixing process, improving mixing efficiency, and shortening the duration of the catalytic reaction.

In some embodiments, a size of each of the plurality of first through-holes 21 is equal to a size of each of the plurality of second through-holes 31.

In some embodiments, the driving assembly 4 is configured to provide power for the rotation of the scraper 22 and the mixing blades 32. An output end of the driving assembly 4 is drivingly connected to the first material pipe 2 and the second material pipe 3. The driving assembly 4 is configured to drive the first material pipe 2 and the second material pipe 3 to rotate at different speeds. The differential rotation of the first material pipe 2 and the second material pipe 3 creates moments in time and space where the first through-holes 21 and the second through-holes 31 become aligned. In some embodiments, two driving assemblies 4 are provided, one of the two driving assemblies 4 drives the rotation of the first material pipe 2 and the other one of the two driving assemblies 4 drives the rotation of the second material pipe 3.

In some embodiments, the driving assembly 4 includes a motor 41, a first bevel gear 42, a second bevel gear 43, and a third bevel gear 44. An output shaft of the motor 41 is drivingly connected to the third bevel gear 44. The first bevel gear 42 is installed on the first material pipe 2, and the second bevel gear 43 is installed on the second material pipe 3. The third bevel gear 44 meshes with the first bevel gear 42 and the second bevel gear 43.

Using the motor 41 as a power source, the third bevel gear 44 connected to the output shaft transmits power to the first bevel gear 42 and the second bevel gear 43 respectively through precise meshing relationships. This arrangement ensures high efficiency in power transmission, reduces energy loss, and enables the first material pipe 2 and the second material pipe 3 to rotate at high speeds with stable power, thereby improving mixing efficiency.

In some embodiments, a transmission ratio between the first bevel gear 42 and the third bevel gear 44 is different from a transmission ratio between the second bevel gear 43 and the third bevel gear 44. For example, the transmission ratio between the first bevel gear 42 and the third bevel gear 44 is 1, and the transmission ratio between the second bevel gear 43 and the third bevel gear 44 is 1.5.

In some embodiments, the purification mechanism 5 is configured to remove impurities in the fluid. The purification mechanism 5 is disposed within the air outlet channel 12 and configured to remove impurities in the fluid, thereby improving the cleanliness of a post-reaction product. For example, the purification mechanism 5 includes a filter screen.

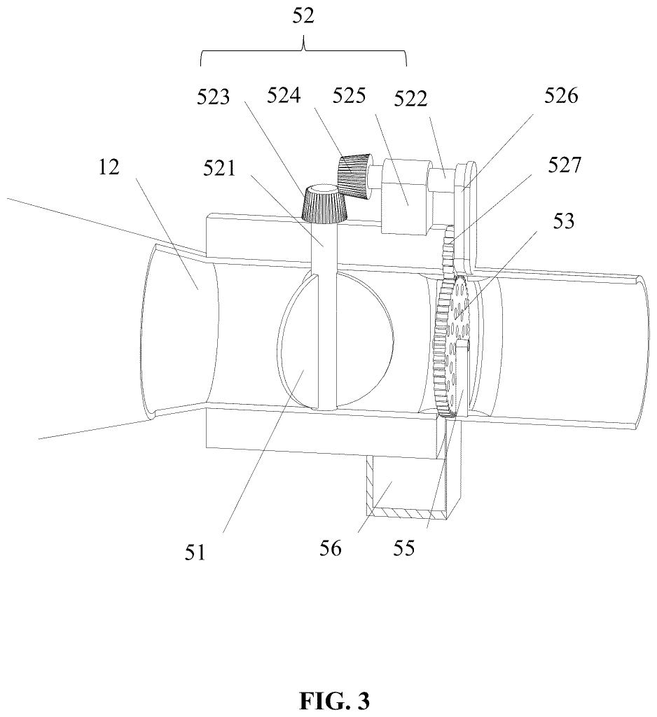

In some embodiments, as shown in FIG. 3, the purification mechanism 5 includes a power fan 51, a transmission assembly 52, and a filter plate 53. The power fan 51 is rotatably connected to the air outlet channel 12, and the filter plate 53 is also rotatably connected to the air outlet channel 12. The filter plate 53 and the air outlet channel 12 are arranged coaxially. The power fan 51 is drivingly connected to an input end of the transmission assembly 52, and an output end of the transmission assembly 52 is drivingly connected to the filter plate 53. The power fan 51 is configured to be driven by a wind force to rotate the filter plate in a circumferential direction of the filter plate 53. The power fan 51 may have three fan blades distributed at intervals. In some embodiments, a rotation axis of the power fan 51 may be perpendicular to an axis of the air outlet channel 12. The power fan 51 is capable of rotating relative to the air outlet channel 12.

When a gas, after undergoing a selective catalytic mixing reaction, is discharged through the air outlet channel 12, a high-speed airflow exerts an impact force on the power fan 51, thereby causing the power fan 51 to rotate, thereby achieving energy recovery and utilization, and providing additional power support for the entire system.

In some embodiments, the purification mechanism 5 includes a scraping strip 54. The scraping strip 54 is fixedly connected to the air outlet channel 12 and contacts an end surface of the filter plate 53, the end surface being close to an input end of the air outlet channel 12. The scraping strip 54 is used to scrape off impurities filtered out by the filter plate 53. The side of the filter plate 53 close to the input end of the air outlet channel 12 refers to an end of the filter plate 53 near to the mixing cylinder 1.

In some embodiments, the purification mechanism 5 includes a fixed block 55. The fixed block 55 is located in the air outlet channel 12 and fixedly connected to the air outlet channel 12. The scraping strip 54 is fixedly connected to the fixed block 55, and the filter plate 53 is located between the fixed block 55 and the scraping strip 54. A portion of the fixed block 55 passes through the filter plate 53 and is connected to a portion of the scraping strip 54. The filter plate 53 may rotate relative to the fixed block 55 and the scraping strip 54. For example, the fixed block 55 serves as a rotating component or a bearing supporting the filter plate 53, enabling the filter plate 53 to rotate smoothly between the scraping strip 54 and the fixed block 55. As a fluid passes through the filter plate 53, the filter plate 53 rotates to enhance a filtration effect, prevent clogging, and extend the service life of the filter plate 53. To further improve the filtration effect, the scraping strip 54 closely contacts an outer surface of the filter plate 53. During the rotation of the filter plate 53, the scraping strip 54 scrapes off impurities and particles adhering to a surface of the filter plate 53, thereby maintaining the cleanliness of the filter plate 53 and unobstructed flow though the filter plate 53.

In some embodiments, the transmission assembly 52 includes a first rotating shaft 521, a second rotating shaft 522, a fourth bevel gear 523, a fifth bevel gear 524, a mounting seat 525, a transmission belt 526, and a transmission gear 527. The first rotating shaft 521 is rotatably connected to the air outlet channel 12, and the power fan 51 is fixedly connected to the first rotating shaft 521. An end of the first rotating shaft 521 extends to an outer side of the air outlet channel 12 and is provided with the fourth bevel gear 523. The fourth bevel gear 523 meshes with the fifth bevel gear 524. The second rotating shaft 522 is rotatably connected to the mounting seat 525. The fifth bevel gear 524 is disposed on the second rotating shaft 522. An outer periphery of the filter plate 53 is provided with teeth. The transmission gear 527 meshes with the teeth on the filter plate 53 and is rotatably connected to the mounting seat 525 through a transmission gear shaft. The transmission belt 526 is wound around the second rotating shaft 522 and the transmission gear shaft. The air outlet channel 12 is provided with a notch for the transmission gear 527 to pass through, which matches the transmission gear 527. When the transmission gear 527 rotates, the transmission gear 527 forms a dynamic seal with the notch of the air outlet channel 12, significantly reducing the leakage of the reaction fluid. The mounting seat 525 is installed at the notch, covering the notch to prevent communication with the external environment.

In some embodiments, the purification mechanism 5 includes a collection box 56 for receiving the impurities filtered by the filter plate 53. The collection box 56 is fixedly connected to the air outlet channel 12. An opening of the collection box 56 is located between the filter plate 53 and the power fan 51 and is in fluid communication with the air outlet channel 12. The opening of the collection box 56 is located below the scraping strip 54.

By way of example, the working principle of the mixing device is as follows: a gas to be treated enters the mixing cylinder 1 through the air inlet channel 13. A pipe carrying the reducing agent, an aqueous urea solution, is rotatably connected to an end of the first material pipe 2. The temperature controller 131 on the air inlet channel 13 regulates the temperature of the incoming gas, ensuring the temperature reaches an optimal reaction temperature when the gas enters the catalytic reaction zone. The motor 41 is activated, causing the output shaft of the motor 41 to drive the rotation of the third bevel gear 44. The third bevel gear 44 meshes with both the first bevel gear 42 and the second bevel gear 43, thereby driving the first material pipe 2 and the second material pipe 3 to rotate at different speeds. The L-shaped scraper 22, rotating with the first material pipe 2, scrapes the inner wall of the mixing cylinder 1 to prevent the deposition or scaling of crystals. The spirally distributed mixing blades 32, rotating with the second material pipe 3, generate a strong stirring effect and vortices, promoting uniform mixing of fluids. When the first through-holes 21 on the first material pipe 2 and the second through-holes 31 on the second material pipe 3 align, the aqueous urea solution is injected from the first material pipe 2, initiating a redox reaction with the gas in the mixing chamber 11. The reacted gas enters the air outlet channel 12 from the mixing cylinder 1. Within the air outlet channel 12, the gas is filtered by the rotating filter plate 53 to remove impurities and particulate matter. The high-speed gas flow drives the rotation of the power fan 51, which, via the transmission assembly 52, provides rotational power to the filter plate 53. As the filter plate 53 rotates relative to the fixed scraping strip 54, the strip scrapes off impurities from the surface of the filter plate, maintaining its filtration effect. This self-cleaning action further enhances the filtration effect by preventing dust from accumulating on the surface of the filter plate, which may impair its effectiveness. Crystals generated by the catalytic reaction fall to the collection channel 14 at the bottom of the mixing cylinder 1. The plug 15 at the bottom of the collection channel 14 allows for controlled discharge of the crystals as needed. The filtered gas is finally discharged from the top of the air outlet channel 12, completing the entire workflow.

In some embodiments, the mixing device further includes a controller. The driving assembly 4 further includes a frequency converter. The frequency converter is configured to control a rotational speed of the motor 41 and is communicatively connected to the controller.

The controller is configured to, at every preset period, determine pressure difference data based on pressure data of the air inlet channel and pressure data of the air outlet channel; determine a target rotational speed based on the pressure difference data and a mixing temperature, and control the rotational speed of the motor through the frequency converter based on the target rotational speed.

The controller includes a Programmable Logic Controller (PLC), a Central Processing Unit (CPU), or the like. The controller may include a remote controller, which is located outside the mixing device.

The frequency converter controls the rotational speed of the motor 41 by varying a frequency or a voltage of the motor 41.

The preset period is a pre-defined time interval. The controller may store a plurality of different preset periods. The plurality of preset periods may be set by an operator based on experience.

In some embodiments, the controller may designate a time point at which the mixing device starts operation as a starting point of the preset period.

The pressure data refers to data reflecting gas pressure in the air inlet channel and the air outlet channel.

In some embodiments, pressure sensors are arranged at the air inlet channel and the air outlet channel. The pressure sensors are configured to collect the gas pressure data.

The pressure difference data refers to data determined based on a difference between the gas pressure in the air inlet channel and the gas pressure in the air outlet channel. For example, if the gas pressure in the air inlet channel is 0.18 MPa and the gas pressure in the air outlet channel is 0.12 MPa, then the pressure difference data is 0.06 MPa.

The mixing temperature refers to a gas temperature inside the mixing chamber 11 of the mixing cylinder 1.

In some embodiments, a temperature sensor is disposed inside the mixing chamber 11. The temperature sensor is configured to acquire the mixing temperature.

The target rotational speed refers to a rotational speed intended to be implemented.

In some embodiments, the controller may obtain the target rotational speed based on a cluster analysis.

Merely by way of example, the cluster analysis may include the following operations: a plurality of cluster vectors composed of historical pressure difference data and historical mixing temperatures may be constructed. For each of the plurality of cluster vectors, a label of the cluster vector is a historical target rotational speed that results in optimal subsequent reaction performance, determined from multiple historical control records corresponding to the cluster vector. The reaction performance may be represented numerically as a weighted sum of a normalized reaction completion time and a gas turbidity in the air outlet channel.

The reaction completion time may be determined by the controller monitoring a concentration change of reactants. For example, the controller may preset a concentration threshold and determine a time when the reactant concentration begins to fall below the concentration threshold as the reaction completion time. The gas turbidity in the air outlet channel may be monitored and determined using a turbidimeter. The turbidimeter may be installed at an outlet of the air outlet channel.

In some embodiments, the optimal reaction performance corresponds to the smallest numerical value generated after the weighted summation. Exemplary normalization manner may include Min-Max normalization, or the like. In some embodiments, weight coefficients for the weighted sum are set by the operator based on experience.

The controller may construct a target vector based on current pressure difference data and a current mixing temperature.

In some embodiments, the controller may perform clustering on the plurality of cluster vectors to obtain a plurality of clusters and designate a cluster to which the target vector belongs as a target cluster. The controller may determine an average value of the labels of the cluster vectors included in the target cluster and designate the average value as the target rotational speed corresponding to the target vector.

In some embodiments, the controller is further configured to determine the target rotational speed based on the pressure difference data and the mixing temperature, in response to a historical pressure difference feature or a historical temperature feature being greater than a corresponding control threshold.

The historical pressure difference feature refers to one or more features related to a pressure difference within a historical time period. For example, the historical pressure difference feature includes pressure difference change rates at historical time points.

The historical time period is a duration extending backwards from a current time point. The duration of the historical time period is set by the user based on experience, e.g., 2 seconds, 5 seconds, etc.

The historical pressure difference feature includes a numerical range of the historical pressure difference data and pressure difference change rates at multiple time points. The numerical range refers to a range of values of the pressure difference. For example, the numerical range of the historical pressure difference data is from a minimum value to a maximum value of the pressure difference within the historical pressure difference data.

The pressure difference change rate may characterize a variation of the pressure difference. For each time point, the pressure difference change rate is a ratio of a pressure difference variation to a pressure difference at a previous time point, where the pressure difference variation is a difference between the pressure difference at the previous time point and a pressure difference at a subsequent time point.

The historical temperature feature refers to one or more features related to temperature within the historical time period. For example, the temperature feature may include mixing temperatures at multiple time points within a period and temperature difference change rates of the mixing temperatures.

The historical temperature feature includes a numerical range of historical mixing temperatures and the temperature difference change rates at multiple time points within the historical time period. The numerical range of the historical mixing temperatures may be from a minimum value to a maximum value of the historical mixing temperatures.

The temperature difference change rate may characterize a variation of the temperature difference. For each time point, the temperature difference change rate is a ratio of a variation in temperature difference to a temperature difference at a previous time point, where the variation in temperature difference is a difference between the temperature difference at the previous time point and a temperature difference at a subsequent time point.

The control threshold refers to a pre-set threshold. The control threshold corresponding to the historical pressure difference feature may include a pressure difference range threshold and a pressure difference change rate threshold. The control threshold corresponding to the historical temperature feature may include a temperature difference range threshold and a temperature difference change rate threshold.

The pressure difference range threshold and the temperature difference range threshold are pre-set range thresholds. The pressure difference range threshold indicates an allowable range size for the pressure difference data. The temperature difference range threshold indicates an allowable range size for the temperature data.

The range size of the pressure difference data may be an interval value between the maximum value and the minimum value of the pressure difference data. The range size of the temperature data may be an interval value between the maximum value and the minimum value of the mixing temperatures.

In some embodiments, the pressure difference range threshold and the temperature difference range threshold may be set by the operator based on experience.

In some embodiments, if the historical pressure difference feature is greater than the pressure difference change rate threshold or the historical temperature feature is greater than the temperature difference change rate threshold, and furthermore, if a plurality of pressure difference change rates corresponding to the historical pressure difference feature or a plurality of temperature difference change rates corresponding to the historical temperature feature all show an upward trend, the controller may determine that the historical pressure difference feature or the historical temperature feature is greater than the corresponding control threshold.

If the historical pressure difference feature is greater than the pressure difference change rate threshold and the historical temperature feature is greater than the temperature difference change rate threshold, and furthermore, if the plurality of pressure difference change rates corresponding to the historical pressure difference feature or the plurality of temperature change rates corresponding to the historical temperature feature all show an upward trend, the controller may determine that the historical pressure difference feature or the historical temperature feature is greater than the corresponding control threshold.

The controller may perform this determination based on any single data point within multiple data points of the historical pressure difference feature or the historical temperature feature.

In some embodiments, the controller may perform fitting on the plurality of pressure difference change rates corresponding to the historical pressure difference feature or the plurality of temperature change rates corresponding to the historical temperature feature to generate a fitted curve. The controller then determines whether the plurality of pressure difference change rates corresponding to the historical pressure difference feature or the plurality of temperature change rates corresponding to the historical temperature feature show an upward trend based on a trajectory of the fitted curve.

In response to a range of the plurality of pressure difference data corresponding to the historical pressure difference feature being greater than the pressure difference range threshold, and a difference range (e.g., a difference between the maximum value and the minimum value) of the multiple temperature data corresponding to the historical temperature feature being greater than the temperature difference range threshold, the controller determines that the historical pressure difference feature or the historical temperature feature is greater than the corresponding control threshold.

In some embodiments, building upon periodic adjustment, the addition of an immediate response mechanism to changes in pressure and temperature enables the mixing device to make faster and more timely adjustments to sudden situations such as blockages.

In some embodiments, the controller is further configured to determine the target rotational speed based on the pressure difference data, the mixing temperature, a blockage feature, and a reaction feature.

The blockage feature is an indicator characterizing a risk of blockage in the air outlet channel. The blockage feature includes a particulate matter content in the gas within the air outlet channel.

The reaction feature is an indicator characterizing reaction performance (e.g., selective catalytic reduction reaction performance). The reaction feature includes an ammonia content and a nitrogen oxide content in the gas within the air outlet channel.

In some embodiments, the controller may determine the blockage feature and the reaction feature based on gas composition data.

In some embodiments, the controller may determine the target rotational speed based on the pressure difference data, the mixing temperature, the blockage feature, and the reaction feature through a cluster analysis.

The cluster vector further includes the historical pressure difference data, the historical mixing temperature, a historical blockage feature, and a historical reaction feature.

More descriptions regarding cluster analysis may be found in relevant descriptions provided above.

In some embodiments, when adjusting the rotational speed of the motor, by further comprehensively considering the reaction performance and the blockage risk, the controller's control strategy becomes more holistic, thereby ensure mixing efficiency while simultaneously balancing catalytic effectiveness and the long-term stability of the mixing device.

In some embodiments, by utilizing real-time pressure difference and mixing temperature, the controller can periodically and automatically adjust the rotational speed of the motor, achieving intelligent control of the mixing process. This approach ensures the efficient operation of the mixing device under varying working conditions.

In some embodiments, the controller is configured to perform the following operations at every preset period: determine the blockage feature and the reaction feature based on the gas composition data of the air outlet channel; determine a target temperature based on the blockage feature and the reaction feature; and control the temperature controller to adjust the gas temperature within the air inlet channel to the target temperature.

The gas composition data refers to chemical components contained in the gas within the air outlet channel and their respective concentrations.

In some embodiments, a gas sensor is disposed within the air outlet channel, and the controller may acquire the gas composition data via the gas sensor.

More descriptions regarding the blockage feature and reaction feature may be found in the relevant descriptions provided above.

The target temperature is a preset, planned temperature value to be controlled. For example, the target temperature includes a pre-set temperature for the temperature controller 131.

The target temperature may be pre-set by the operator.

In some embodiments, the controller may determine the target temperature through a first vector database.

For example, the controller may retrieve data from the first vector database based on the target vector to determine the target temperature.

The first vector database contains a large number of feature vectors. These feature vectors include historical blockage features and historical reaction features. The label for a feature vector is a historical gas temperature that is selected from multiple historical temperature adjustments associated with that feature vector and results in the optimal subsequent reaction performance. The controller may construct the first vector database by determining the feature vectors and their labels based on historical data.

The target vector includes a current blockage feature and a current reaction feature.

In some embodiments, the controller may retrieve a plurality of feature vectors whose similarity to the target vector is greater than a similarity threshold, and designate an average value of the labels corresponding to the plurality of feature vectors as the gas temperature corresponding to the target vector.

The similarity may be obtained by calculating a vector distance between the target vector and a feature vector.

The similarity threshold may be set by the operator based on experience.

In some embodiments, by real-time monitoring of the reaction results and blockage status indicated by the gas in the air outlet channel, and using this information to intelligently regulate the temperature of the gas entering via the air inlet channel, closed-loop optimal control of the catalytic reaction temperature can be achieved, thereby facilitating the identification of the optimal balance between improving reaction efficiency and reducing blockages.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A mixing device for a selective catalytic reduction fluid generator, comprising:
a mixing cylinder having a mixing chamber, wherein an air outlet channel is formed on a right end surface of the mixing cylinder, and an air inlet channel is formed on a left end surface of the mixing cylinder;
a first material pipe extending into the mixing cylinder, the first material pipe and the mixing cylinder being coaxially arranged, wherein a plurality of first through-holes are provided on the first material pipe at intervals along an axial direction of the first material pipe, and a scraper is fixed on the first material pipe, the scraper being located in the mixing chamber of the mixing cylinder and in contact with an inner wall of the mixing chamber of the mixing cylinder;
a second material pipe extending into the mixing cylinder, the second material pipe being sleeved on the first material pipe, wherein a plurality of second through-holes are provided on the second material pipe at intervals along an axial direction of the second material pipe, and in a plane of rotation, each of the plurality of first through-holes corresponds to one of the plurality of second through-holes, such that when the plurality of first through-holes and the plurality of second through-holes are aligned, a pipe lumen of the first material pipe is in fluid communication with the mixing chamber of the mixing cylinder; and mixing blades are installed on the second material pipe;
a driving assembly for providing power for rotation of the scraper and the mixing blades, wherein an output end of the driving assembly is drivingly connected to the first material pipe and the second material pipe to drive the first material pipe and the second material pipe to rotate at different speeds; and
a purification mechanism for removing impurities in a fluid, the purification mechanism being disposed in the air outlet channel.

2. The mixing device of claim 1, wherein the mixing blades are spirally distributed.

3. The mixing device of claim 1, wherein the driving assembly comprises a motor, a first bevel gear, a second bevel gear, and a third bevel gear, an output shaft of the motor is drivingly connected to the third bevel gear, the first bevel gear is installed on the first material pipe, the second bevel gear is installed on the second material pipe, and the third bevel gear meshes with the first bevel gear and the second bevel gear; and
a transmission ratio between the first bevel gear and the third bevel gear is different from a transmission ratio between the second bevel gear and the third bevel gear.

4. The mixing device of claim 1, wherein the purification mechanism comprises a power fan, a transmission assembly, and a filter plate, the power fan is rotatably connected to the air outlet channel, the filter plate is rotatably connected to the air outlet channel, the filter plate and the air outlet channel are coaxially arranged, the power fan is drivingly connected to an input end of the transmission assembly, an output end of the transmission assembly is drivingly connected to the filter plate, and the power fan is configured to be driven by a wind force to rotate the filter plate in a circumferential direction of the filter plate.

5. The mixing device of claim 4, wherein the purification mechanism further comprises a scraping strip, the scraping strip is fixedly connected to the air outlet channel, and the scraping strip contacts an end surface of the filter plate, the end surface being close to an input end of the air outlet channel.

6. The mixing device of claim 5, wherein the purification mechanism further comprises a fixed block, the fixed block is located in the air outlet channel and fixedly connected to the air outlet channel, the filter plate is fixedly connected to the fixed block, and the filter plate is located between the fixed block and the scraping strip.

7. The mixing device of claim 4, wherein the transmission assembly comprises a first rotating shaft, a second rotating shaft, a fourth bevel gear, a fifth bevel gear, a mounting seat, a transmission belt, and a transmission gear, the first rotating shaft is rotatably connected to the air outlet channel, the power fan is fixedly connected to the first rotating shaft, an end of the first rotating shaft extends to an outer side of the air outlet channel and is provided with the fourth bevel gear, the fourth bevel gear meshes with the fifth bevel gear, the second rotating shaft is rotatably connected to the mounting seat, the fifth bevel gear is disposed on the second rotating shaft, an outer periphery of the filter plate is provided with teeth, the transmission gear meshes with the teeth on the filter plate, the transmission gear is rotatably connected to the mounting seat through a transmission gear shaft, and the transmission belt is wound around the second rotating shaft and the transmission gear shaft.

8. The mixing device of claim 4, wherein the purification mechanism further comprises a collection box for accommodating impurities filtered by the filter plate, the collection box is fixedly connected to the air outlet channel, a box opening of the collection box is located between the filter plate and the power fan, and the box opening of the collection box is in fluid communication with the air outlet channel.

9. The mixing device of claim 1, wherein a temperature controller is installed on the air inlet channel.

10. The mixing device of claim 1, wherein a collection channel is formed on the mixing cylinder, and a plug is disposed in the collection channel.

11. The mixing device of claim 3, wherein the mixing device further comprises a controller;
the driving assembly further comprises a frequency converter, the frequency converter is configured to control a rotational speed of the motor; the frequency converter is communicatively connected to the controller, and the controller is configured to perform, at every preset period, operations including:
determining pressure difference data based on pressure data of the air inlet channel and pressure data of the air outlet channel; and
determining a target rotational speed based on the pressure difference data and a mixing temperature, and controlling the rotational speed of the motor through the frequency converter based on the target rotational speed.

12. The mixing device of claim 11, wherein the controller is further configured to:
in response to a historical pressure difference feature or a historical temperature feature being greater than a corresponding control threshold, determine the target rotational speed based on the pressure difference data and the mixing temperature.

13. The mixing device of claim 11, wherein the controller is further configured to:
determine the target rotational speed based on the pressure difference data, the mixing temperature, a blockage feature, and a reaction feature.

14. The mixing device of claim 9, wherein the mixing device further comprises a controller; the temperature controller is communicatively connected to the controller, and the controller is configured to perform, at every preset period, operations including:
determining a blockage feature and a reaction feature based on gas composition data of the air outlet channel;
determining a target temperature based on the blockage feature and the reaction feature; and
controlling the temperature controller to adjust a gas temperature in the air inlet channel to the target temperature.
